(19) United States
(12) Patent Application Publication
(10) Pub. No.: US 2015/0168136 A1
(43) Pub. Date: Jun. 18, 2015

(54) ESTIMATING THREE-DIMENSIONAL POSITION AND ORIENTATION OF ARTICULATED MACHINE USING ONE OR MORE IMAGE-CAPTURING DEVICES AND ONE OR MORE MARKERS

(71) Applicant: The Regents of the University of Michigan, Ann Arbor, MI (US)

(72) Inventors: Vineet R. Kamat, Ann Arbor, MI (US); Chen Feng, Ann Arbor, MI (US); Suyang Dong, Ann Arbor, MI (US); Manu Akula, Ann Arbor, MI (US); Yong Xiao, Ann Arbor, MI (US); Kurt M. Lundeen, Ann Arbor, MI (US); Nicholas D. Fredericks, Ann Arbor, MI (US)

(21) Appl. No.: 14/568,870

(22) Filed: Dec. 12, 2014

Related U.S. Application Data
(60) Provisional application No. 61/914,999, filed on Dec. 12, 2013.

(51) Int. Cl. G01B 11/28; H04N 7/18; B60R 11/04

(52) U.S. Cl. CPC G01B 11/28; B60R 11/04; H04N 7/18

(57) ABSTRACT

A method and system of estimating the three-dimensional (3D) position and orientation (pose) of an articulated machine, such as an excavator, involves the use of one or more marker(s) and one or more image-capturing device(s). Images of the marker(s) are captured via the image-capturing device(s), and the captured images are used to determine pose. Furthermore, the pose of non-articulated components of the articulated machine, of articulated components of the articulated machine, and of end effectors of the articulated machine can all be estimated with the method and system.

### CROSS-REFERENCE TO RELATED APPLICATION

This application claims the benefit of U.S. Provisional Application No. 61/914,999 filed Dec. 12, 2013, the entire contents of which are hereby incorporated by reference.

### GOVERNMENT LICENSE RIGHTS

This invention was made with government support under CMMI0927475 awarded by the National Science Foundation. The government has certain rights in the invention.

### TECHNICAL FIELD

This disclosure relates generally to estimating the three-dimensional position and orientation of an articulated machine, and more particularly to making these estimations with the use of one or more image-capturing device(s) and one or more marker(s).

### BACKGROUND

Articulated machines, such as construction equipment and robots, typically have one or more joints about which its components pivot. An excavator, for instance, is a piece of equipment that conventionally includes a cabin, a boom, a stick, and a bucket. The cabin houses the excavator's controls and seats an operator. The boom is pivotally hinged to the cabin, and the stick is in turn pivotally hinged to the boom. Likewise, the bucket is pivotally hinged to the stick and is the component of the excavator that digs into the ground and sets removed earth aside. The boom and stick are articulated components in this example, while the cabin is a non-articulated component and base, and the bucket is an articulated component and end effector. In machine control applications, attempts have been made to monitor the position and orientation (also called pose) of articulated components of the articulated machines. Knowing the pose of these components is useful for jobsite safety purposes like avoiding unwanted impact with buried utilities when digging with the bucket, and for productivity purposes like autonomous and semi-autonomous machine command. The previous attempts involve sensors and global positioning systems (GPS) and can be expensive for a large part of the interested market. The previous attempts can also be inaccurate—for instance, global positioning systems can experience issues functioning around tall buildings and other structures; this is known as GPS shadow.

### SUMMARY

According to one embodiment, a method of estimating the three-dimensional position and orientation of an articulated machine in real-time using one or more image-capturing device(s) and one or more marker(s) includes several steps. One step involves providing the image-capturing device(s) mounted to the articulated machine, or providing the image-capturing device(s) located at a site near the articulated machine. Another step involves providing the marker(s) attached to the articulated machine, or providing the marker(s) located at a site near the articulated machine. Yet another step involves capturing images of the marker(s) by way of the image-capturing device(s). And yet another step involves determining the position and orientation of the image-capturing device(s) with respect to the marker(s) based on the captured images of the marker(s), or determining the position and orientation of the marker(s) with respect to the image-capturing device(s) based on the captured images of the marker(s). The position and orientation of the image-capturing device(s) constitutes the position and orientation of the articulated machine at the mounting of the image-capturing device(s) to the articulated machine; or, the position and orientation of the marker(s) constitutes the position and orientation of the articulated machine at the attachment of the marker(s) to the articulated machine.

According to another embodiment, a method of estimating the three-dimensional position and orientation of an articulated machine in real-time using one or more image-capturing device(s) and one or more marker(s) includes several steps. One step involves providing the image-capturing device(s) mounted to the articulated machine, or providing the image-capturing device(s) located at a site near the articulated machine. Another step involves providing the marker(s) attached to the articulated machine, or providing the marker(s) located at a site near the articulated machine. Yet another step involves capturing images of the marker(s) by way of the image-capturing device(s). And yet another step involves determining the position and orientation of the image-capturing device(s) with respect to the marker(s) based on the captured images of the marker(s), or determining the position and orientation of the marker(s) with respect to the image-capturing device(s) based on the captured images of the marker(s). Another step involves providing a benchmark. The benchmark has a predetermined position and orientation relative to the image-capturing device(s), or the benchmark has a predetermined position and orientation relative to the marker(s). Yet another step involves determining the position and orientation of the image-capturing device(s) with respect to the benchmark based on the predetermined position and orientation of the benchmark relative to the marker(s); or involves determining the position and orientation of the marker(s) with respect to the benchmark based on the predetermined position and orientation of the benchmark relative to the image-capturing device(s).

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is an enlarged view of an example articulated machine with a marker attached to the machine and an image-capturing device mounted on the machine;

FIG. 2 is a diagrammatic representation of a registration algorithm framework that can be used in determining the position and orientation of the image-capturing device of FIG. 1;

FIG. 3 is a diagrammatic representation of another registration algorithm framework that can be used in determining the position and orientation of the image-capturing device of FIG. 1;

FIG. 4 is an enlarged view of the articulated machine of FIG. 1, this time having a pair of markers attached to the machine and a pair of image-capturing devices mounted on the machine;

FIG. 5 is a perspective view of the articulated machine of FIG. 1, this time having three markers attached to the machine, a pair of image-capturing devices mounted on the machine, and another image-capturing device located near the machine;

FIG. 6 is a schematic showing mathematical representations of position and orientation of articulated components of an articulated machine;

FIG. 7 is a perspective view of an example marker assembly that can be used to mimic movement action of an articulated component;

FIG. 8 is a perspective view of the marker assembly of FIG. 7, showing internal parts of the assembly;

FIG. 9 is an enlarged view of the articulated machine of FIG. 1, this time having image-capturing devices aimed at markers located at a site on the ground away from the articulated machine;

FIG. 10 is a perspective view of the articulated machine of FIG. 1, this time having a marker located near the machine and an image-capturing device mounted on the machine;

FIG. 11 is a perspective view of the articulated machine of FIG. 1, this time having a pair of markers attached to the machine and a pair of image-capturing devices located near the machine;

FIG. 12 is a perspective view of the articulated machine of FIG. 1, this time having one marker located near the machine and another marker attached to the machine, and having a pair of image-capturing devices mounted on the machine;

FIG. 13 is a perspective view of an example marker assembly that can be used to mimic movement of an articulated component and end effector;

FIG. 14 is a perspective view of another example marker assembly that can be used to mimic movement of an articulated component and end effector; and

FIG. 15 is a perspective view of an example cable potentiometer that can be used to measure angles of a pivotally hinged end effector.

### DETAILED DESCRIPTION

Referring to the drawings, the figures depict a method and system of estimating the three-dimensional (3D) position and orientation (also referred to as pose) of articulated components of an articulated machine with the use of one or more marker(s) and one or more image-capturing device(s). In some examples, the method and system can estimate pose at a level of accuracy and speed not accomplished in previous attempts, and at a level suitable for making estimations in real-time applications. Further, because the method and system include one or more marker(s) and one or more image-capturing device(s)—instead of solely relying on sensors and global positioning systems (GPS) like in previous attempts—the method and system are affordable for a larger part of the interested market than the previous attempts and do not necessarily experience the issues of global positioning systems functioning around tall buildings and other structures.

Estimating pose is useful in machine control, augmented reality, computer vision, robotics, and other applications. For example, knowing the pose of an equipment's articulated components can make construction jobsites safer by helping avoid unintentional impact between the components and buried utilities, and can facilitate autonomous and semi-autonomous equipment command. Although shown and described as employed with an excavator 10, the method and system of estimating 3D pose has broader applications and can also work with other articulated machines including construction equipment like backhoe loaders, compact loaders, draglines, mining shovels, off-highway trucks, material handlers, and cranes; and including robots like industrial robots and surgical robots. Still, other articulated machines and their articulated components are possible, as well as other applications and functionalities.

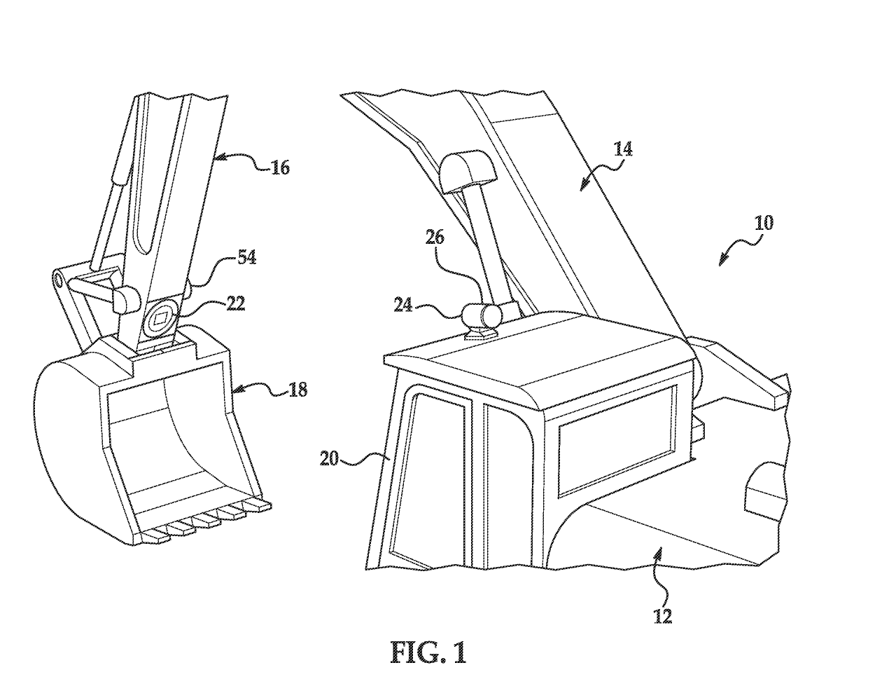

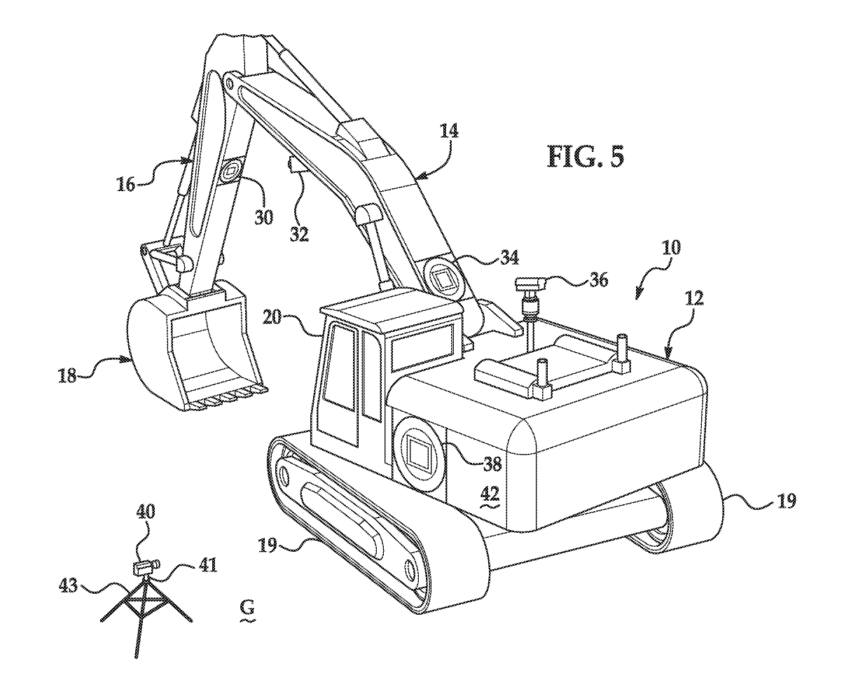

In the excavator 10 example, and referring now particularly to FIG. 1, the excavator includes a base 12, a boom 14, a stick 16, and a bucket 18. The base 12 moves forward and backward via its crawlers 19 (FIG. 5), and rotates left and right about the crawlers and brings the boom 14, stick 16, and bucket 18 with it. A cabin 20 is framed to the base 12 and houses the excavator's controls and seats an operator. The boom 14 is pivotally hinged to the base 12, and the stick 16 is pivotally hinged to the boom. Likewise, the bucket 18 is pivotally hinged to the stick 16 and is dug into the ground and removes earth during use of the excavator 10. In other articulated machines, components such as the bucket 18 are sometimes referred to as the end effector. In this example, the excavator 10 constitutes the articulated machine, the base 12 constitutes a non-articulated component, and the boom 14, stick 16, and bucket 18 constitute articulated components of the excavator.

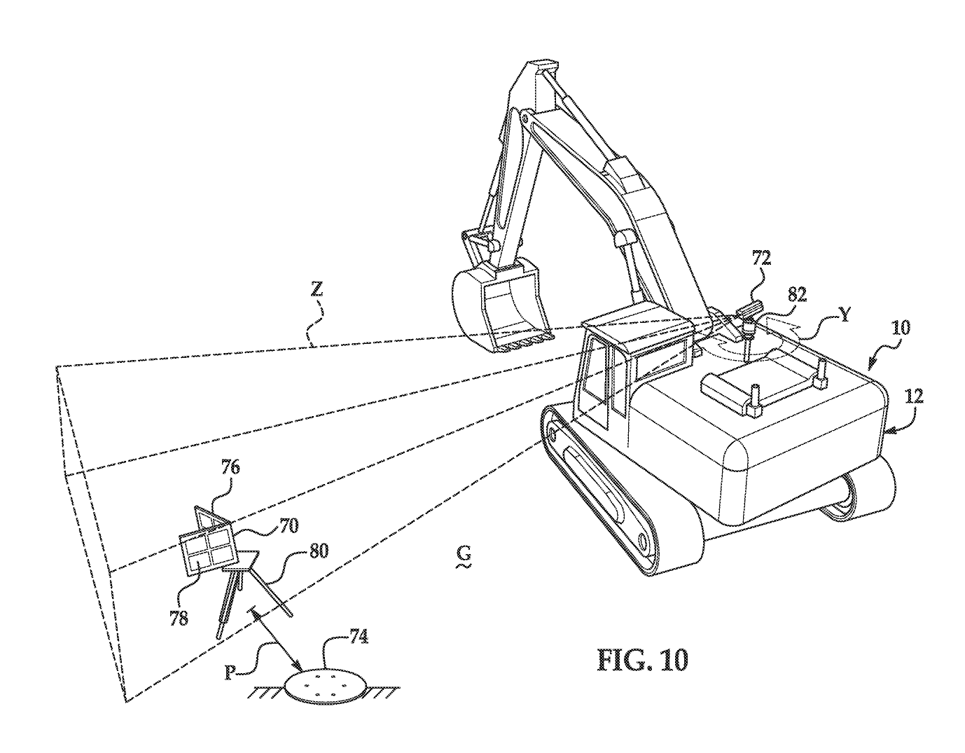

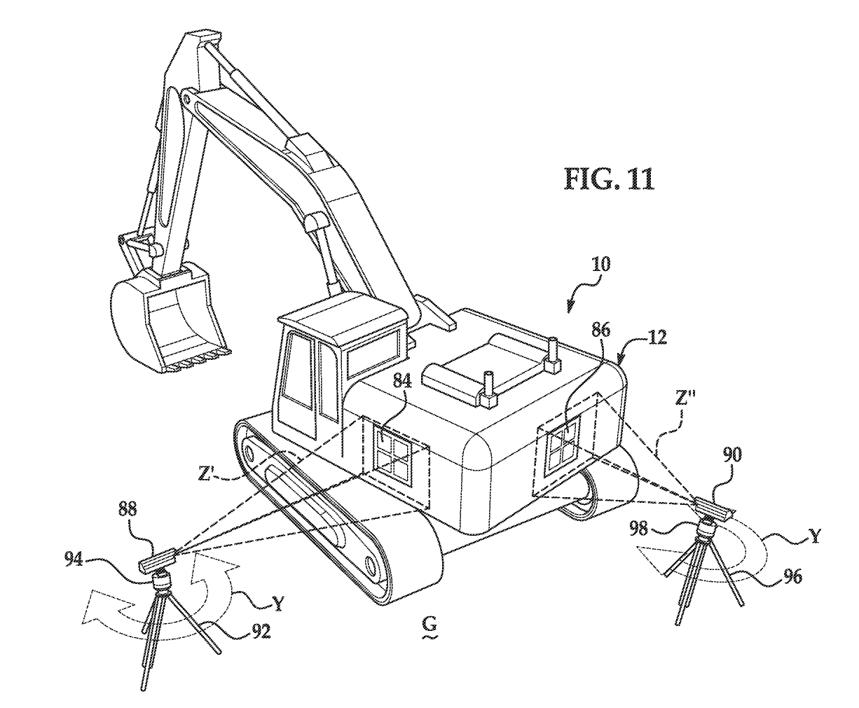

The method and system of estimating 3D pose detailed in this description include one or more marker(s) and one or more image-capturing device(s). The markers can be a natural marker, a fiducial marker, or a combined natural and fiducial marker. In general, natural markers have image designs that typically lack symmetry and usually have no pre-determined visual features and designs. For instance, any common image like a company or university logo or a photo can serve as a natural marker. Fiducial markers, on the other hand, typically have image designs that are specifically arranged such as simple black and white geometric patterns made up of circles, squares, lines, sharp corners, or a combination of these items or other items. Usually, fiducial markers present pre-determined visual features that are easier to detect by pose estimation methods and systems than natural markers, and demand less computational effort than natural markers. In some examples detailed in this description, the markers have single planar conformations and attach to planar surfaces of the excavator 10; for instance, the markers can be printed on form board and attached to the side of the excavator as shown in FIG. 11. These types of markers are two-dimensional markers. In other examples, the markers have multi-planar conformations and are carried by stands; for instance, the markers can be made up of two planar boards arranged at an angle relative to each other as shown in FIG. 10. These types of markers are three-dimensional markers. Still, the markers could have other conformations. Depending on the design and construction of the markers, such as what they are composed of, the markers can be attached to the articulated machine via various techniques including, but not limited to, adhesion, clipping, bolting, welding, clamping, or pinning And its attachment could involve other components that make attaching easier, or has some other purpose, such as a mounting plate or board, a stand, a frame, or something else. Furthermore, where more than one marker is used in the same method and system, the multiple markers can have different image designs relative to one another so that the method and system can more readily distinguish among the different markers. Lastly, in other examples other markers can be suitable for use with the method and system of estimating 3D pose, including markers that do not necessarily have a planar conformation.

The image-capturing devices are aimed at the markers in order to take a series of image frames of the markers within an anticipated field of the markers' movements. The image-capturing devices can be mounted on the articulated machine such as on an articulated component of the machine, or on a non-articulated component of the machine like the base 12 in the excavator 10 example. They can also be mounted at a location near the articulated machine and not necessarily directly on it. Whatever their location, the image-capturing devices can be mounted via various techniques including, but not limited to, adhesion, bolting, welding, or clamping; and its mounting could involve other components such as pedestals, platforms, stands, or something else. When there is more than one image-capturing device, they are networked (e.g., parallel networking). In the example detailed in this description, the image-capturing devices are cameras like a red, green, and blue (RGB) camera, a network camera, a combination of these, or another type. An image resolution of 1280×960 pixels has been found suitable for the method and system of estimating 3D pose, but other image resolutions are possible and indeed a greater image resolution may improve the accuracy of the method and system. One specific example of a camera is supplied by the company Point Grey Research, Inc. of Richmond, British Columbia, Canada (ww2.ptgrey.com) under the product name Firefly MV CMOS camera. Lastly, in other examples other image-capturing devices can be suitable for use with the method and system detailed herein including computer vision devices.

Referring again particularly to FIG. 1, in a first example the method and system of estimating 3D pose includes a single marker 22 and a single image-capturing device 24. Here, the marker 22 is a natural marker with a planar conformation. The marker 22 is attached to a planar surface of the stick 16 at a site located nearest to the bucket 18 and adjacent a pivotal hinge between the bucket and stick. This site is close to the bucket 18 since in some cases if the marker 22 is attached directly to the bucket its attachment could be impaired and damaged when the bucket digs into the ground during use. But in other examples the markers 22 could be attached directly to the bucket 18. In one specific example, the marker 22 is an image of a circular university logo and is printed on a square aluminum plate. The image-capturing device 24 is a camera 26 mounted to a roof of the cabin 20. The camera 26 is aimed at the marker 22 so that the camera can take images of the marker as the marker moves up and down and fore and aft with the stick 16 and bucket 18 relative to the cabin 20.

In general, the method and system of estimating 3D pose include several steps that can be implemented in a computer program product and/or a controller having instructions embodied in a computer readable medium with a non-transient data storage device. Further, the steps can utilize various algorithms, models, formulae, representations, and other functionality. The computer program product and/or controller can have hardware, software, firmware, or other like components configured and programmed to perform the steps, and can employ memory components, processing components, logic components, lookup tables, routines, modules, data structures, or other like components. Still further, the computer program and/or controller can be provided with instructions in source code, object code, executable codes, or other formats. Moreover, while this description details examples of algorithms, models, formulae, and representations, skilled artisans will appreciate that other algorithms, models, formulae, and representations may be used as suitable alternatives. The computer program product and/or controller may be one or more discrete component(s) or may be integrated into the image-capturing devices.

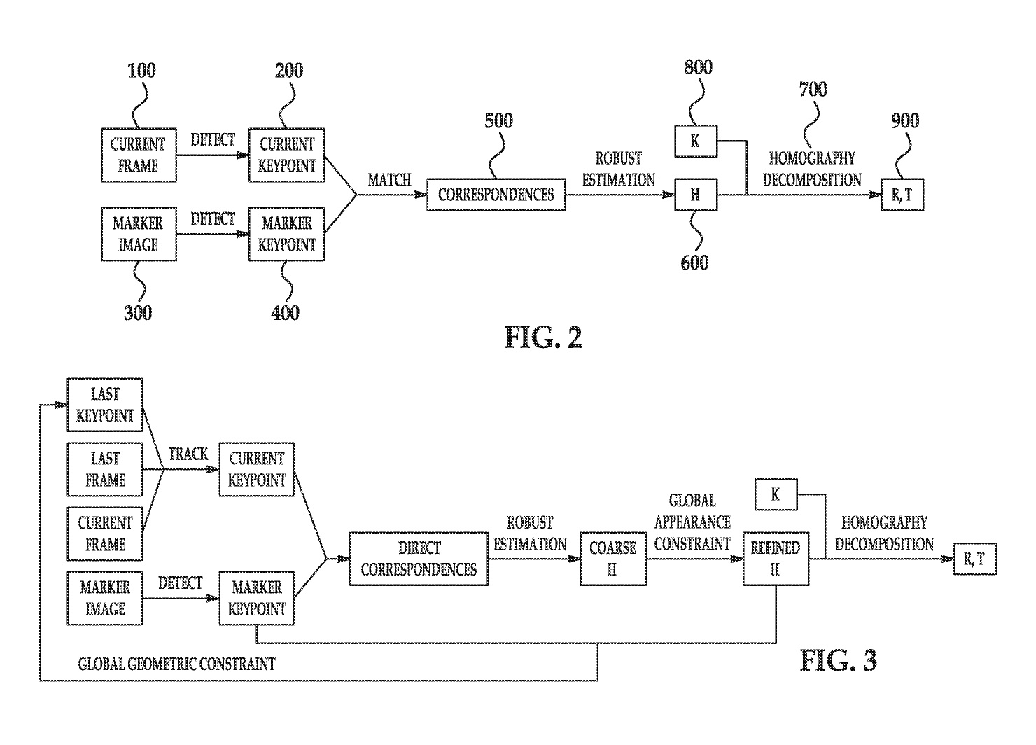

In FIG. 1, the method and system of estimating the 3D pose of the marker 22 involves determining the 3D pose of the camera 26. The determination is an approximation, yet suitably accurate. The 3D pose of the camera 26 can be determined by transformation. Transformation estimates the relative position and orientation between a camera and marker, and can be carried out in many ways. One way involves solving the Perspective-n-Point (PnP) problem with the use of the Levenberg-Marquardt algorithm (LMA); this can be suitable when the markers have multi-planar conformations. Transformation can also involve a registration algorithm framework. Different registration algorithm frameworks can be employed for this purpose in different examples, and the exact registration algorithm framework utilized may depend upon—among other factors—the application, the type of marker, the desired level of accuracy and speed for making the determination, and the desired level of computational effort to be carried out. FIG. 2 is a representation of a first example registration algorithm framework that can be used to determine the 3D pose of the camera 26. Skilled artisans may recognize FIG. 2 as a homography-from-detection registration algorithm framework. In a step 100, image frames are received from the camera's image-capturing capabilities. The image frames include images of the marker 22, as well as images of the surrounding environment which in this example might include images of things commonly found in a construction jobsite. For each individual image frame received, a set of first visual features (also called keypoints) is detected in the image frame (step 200). Also, for each individual image frame received, a set of second visual features is detected on a marker image 300 of the marker 22 in the image frame (step 400). The set of second visual features are pre-determined So-called interest point detection algorithms can be employed for these steps, as will be known by skilled artisans.

In a step 500, correspondences are established between the sets of first and second visual features. That is, corresponding points are matched up between the set of first visual features and the set of second visual features based on their local appearances. Again here, so-called matching algorithms can be employed for this step, as will be known by skilled artisans. Next, in a step 600 a homography is determined between the image frame and the marker image 300 of the marker 22 based on the established correspondences of step 500. In general, homography finds the transformation between the plane of the marker image 300 and the plane of the camera 26, which contains the image frame. Homography maps points on the marker image 300 to their corresponding points on the image frame by employing, in one example, equation (i):

s[x′,y′,1]^{T}=H[x,y,1]^{T}

where H is a three-by-three (3×3) matrix representing the homography, (x, y) and (x′, y′) are the corresponding points on the marker image 300 and the image frame, and s is an unknown scaling parameter. Homography between two planes encodes the pose information of one plane relative to another. From projective geometry, skilled artisans will know that with four or more point correspondences between two planes, the homography of the planes can be determined by solving a set of linear equations.

After step 600, the 3D pose of the plane of the camera 26 with respect to the plane of the marker image 300 can be determined based on the homography. One way of carrying this out is through homography decomposition, step 700. In one example, if a point's three-dimensional coordinate is (X, Y, Z) and its image on the plane of the camera 26 has a two-dimensional coordinate of (x, y), and if it is assumed that the camera is already calibrated and the focal length and principle point position are known, the camera projection model is (equation (ii)):

$${[ x , y , 1 ]}^{T} ∼ {P [ X , Y , Z , 1 ]}^{T} ∼ {K [ R , T ] [ X , Y , Z , 1 ]}^{T}$$

where ˜ means the two vectors are equal up to a scale parameter, that is, equal in the sense of projective geometry; and K (denoted by numeral 800 in FIG. 2) is a calibration matrix of the camera 26 that stores the camera's focal length and other camera parameters that can be known or calibrated in advance. Since, in this example, the marker image 300 is a two-dimensional plane, it can be set to be on the X-Y plane without losing generality. Hence, equation (ii) can be rewritten as (equation (iii)):

$${[ x , y , 1 ]}^{T} ∼ {K [ {r}_{1} , {r}_{2} , {r}_{3} , T ] [ X , Y , 0 , 1 ]}^{T} ∼ {K [ {r}_{1} , {t}_{2} , T ] [ X , Y , 1 ]}^{T} ∼ {H [ X , Y1 ]}^{T}$$

where n is the ith column of R.

From equation (iii), the following equations can be determined which decompose the homography H between the image frame and the marker image 300 into R and T (equation (iv)):

R=[a₁,a₂,a₁×a₂]

T=a₃

where R is a rotation matrix representing the orientation of camera 26; T is the translation vector representing the position of the camera's center (in other words, R and T represent the 3D pose of the camera 26, step 900); aᵢ is the ith of matrix K⁻¹H=[a₁, a₂, a₃] and “×” means the cross product. It is worth noting here that the matrix to be decomposed is K⁻¹H rather than H; this means that in some cases the camera 26 should be calibrated beforehand in order to obtain the K matrix.

FIG. 3 is a representation of a second example registration algorithm framework that can be used to determine the 3D pose of the camera 26. This registration algorithm framework is similar in some ways to the first example registration algorithm framework presented in FIG. 2, and the similarities will not be repeated here. And like the first example registration algorithm framework, skilled artisans will be familiar with the second example registration algorithm framework. Unlike the first example, the second example registration algorithm framework employs two global constraints in order to resolve what-is-known-as jitter and drift effects that, when present, can cause errors in determining the 3D pose of the camera 26. The global constraints are denoted in FIG. 3 as the GLOBAL APPEARANCE CONSTRAINT and the GLOBAL GEOMETRIC CONSTRAINT. These two global constraints have been found to preclude the unwanted jitter and drift effects from propagating between consecutive image frames, and hence limit or altogether eliminate the attendant determination errors. The jitter and drift effects are not always present in these determinations. Yet another example of a registration algorithm framework that could be used in some cases to determine the 3D pose of the camera 26 is a homography-from-tracking registration algorithm framework. Again here, skilled artisans will be familiar with homography-from-tracking registration algorithm frameworks. Still, other examples of determining 3D pose between the camera and marker exist, and the method and system of estimating 3D pose detailed in this description is not limited to any of the examples described or depicted herein.

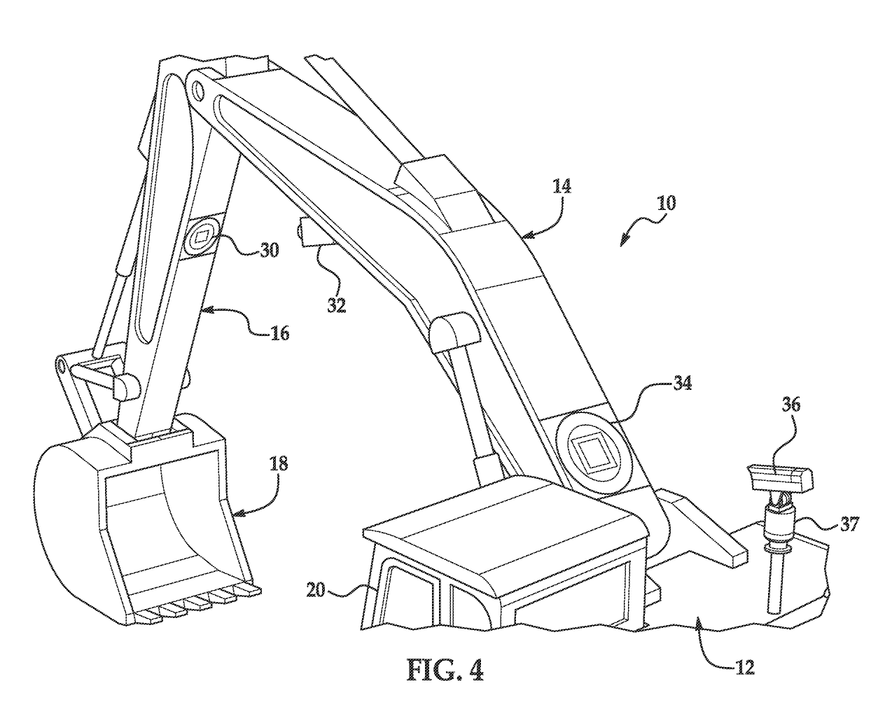

Referring now to FIG. 4, in a second example the method and system of estimating 3D pose includes a first marker 30 and a first camera 32, and a second marker 34 and a second camera 36. The first camera 32 is aimed at the first marker 30 in order to take a series of image frames of the first marker within an anticipated field of the marker's movement. Likewise, the second camera 36 is aimed at the second marker 34 in order to take a series of image frames of the second marker within an anticipated field of the marker's movement. As before, the first and second markers 30, 34 are natural markers with planar conformations in this example. The first marker 30 is attached to a planar surface of the stick 16 at a site about midway of the stick's longitudinal extent, and the second marker 34 is attached to a planar surface of the boom 14 at a site close to the base 12 and adjacent a pivotal hinge between the boom and base. The first camera 32 is mounted to the boom 14 at a site about midway of the boom's longitudinal extent, and the second camera 36 is mounted to a roof of the base 12 at a site to the side of the cabin 20. The second camera 36 can be carried by a motor 37 that tilts the second camera up and down (i.e., pitch) to follow movement of the second marker 34. This second example addresses possible occlusion issues that may arise in the first example of FIG. 1 when an object obstructs the line of sight of the camera 26 and precludes the camera from taking images of the marker 22. The second example accomplishes this by having a pair of markers and a pair of cameras that together represent a tracking chain.

Referring now to FIG. 5, in a third example the method and system of estimating 3D pose includes the first marker 30 and first camera 32 of the example of FIG. 4, the second marker 34 and second camera 36 of FIG. 4, and a third marker 38 and a third camera 40. The first and second markers 30, 34 and first and second cameras 32, 36 can be the same as previously described. The third camera 40, on the other hand, is aimed at the third marker 38 in order to take a series of image frames of the third marker within an anticipated field of the marker's movement. The third marker 38 is a natural marker with a planar conformation in this example. The third marker 38 is attached to a planar surface at a site on a side wall 42 of the base 12. The third camera 40 is located on the ground G via a stand 43 at a site a set distance away from the excavator 10 but still within sight of the excavator. The third camera 40 can be carried by a motor 41 that swivels the third camera side-to-side and left-to-right (i.e., yaw) to follow movement of the third marker 38. This third example can determine the 3D poses of the cameras 32, 36, and 40 with respect to the ground G, as opposed to the examples of FIGS. 1 and 4 which make the determination relative to the base 12 that rotates left and right about its crawlers 19. In this way, the third example of the method and system can determine the 3D pose of the excavator's articulated components when the base 12 rotates side-to-side relative to the third camera 40.

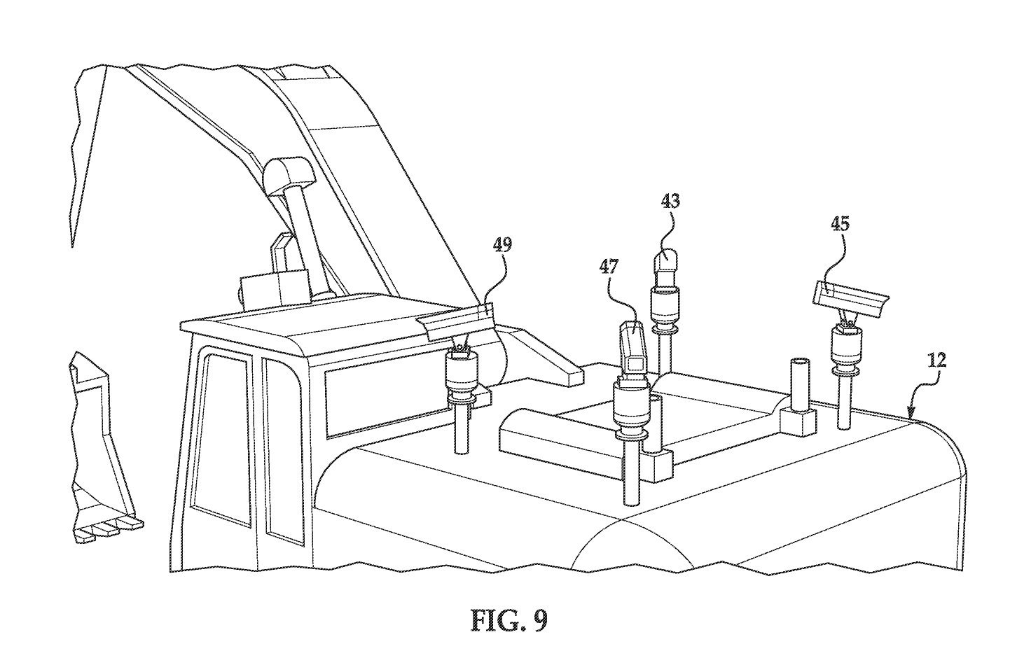

Referring now to FIG. 9, in a fourth example the method and system of estimating 3D pose can include the different markers and cameras of the previous examples or a combination of them, and further can include one or more camera(s) aimed at one or more corresponding markers located at a site on the ground G a set distance away from the excavator 10. This type of camera and marker set-up is known as a sentinel set-up. It provides a local coordinate system that determines the 3D poses of the markers attached to the excavator 10 relative to one another and relative to the ground G. In the specific example of FIG. 9, the method and system further includes a first camera 43, a second camera 45, a third camera 47, and a fourth camera 49, all of which are mounted to the base 12 of the excavator 10. All of these cameras 43, 45, 47, 49 can be aimed at four separate markers attached to stands set on the ground G.

In the different examples detailed thus far in the description, once the 3D pose of the camera(s) relative to the respective marker(s) are determined, the method and system can now determine the 3D pose of the respective marker(s) relative to components of the articulated machine such as the cabin 20 in the excavator 10 example. In one example, determining the 3D pose of the marker(s) involves forward kinematic calculations. In general, forward kinematic calculations in the examples detailed in this description use kinematic equations and the 3D pose of the camera(s) relative to the respective marker(s) previously determined, as well as pre-known 3D poses of the camera(s) relative to component(s) of the excavator 10 and pre-known 3D poses of the marker(s) relative to component(s) of the excavator. In the example of FIG. 1, for instance, the 3D pose of the marker 22 with respect to the cabin 20 can be determined by the equation:

(Rₘₐᵣₖₑᵣ^{cabin},tₘₐᵣₖₑᵣ^{cabin})=(R_{camera}^{cabin},Rₘₐᵣₖₑᵣ^{camera},R_{camera}^{cabin},tₘₐᵣₖₑᵣ^{camera}+t_{camera}^{cabin})

where (R_{camera}^{cabin},t_{camera}^{cabin}) is a pre-known 3D pose of the camera 26 with respect to the cabin 20 (R stands for rotation, and T stands for translation), and (Rₘₐᵣₖₑᵣ^{camera},tₘₐᵣₖₑᵣ^{camera}) is the 3D pose of the camera 26 with respect to the marker 22 determined by the registration algorithm framework. The pre-known 3D pose of the camera 26 with respect to the cabin 20 can be established once the camera is mounted on top of the cabin's roof. After the 3D pose of the marker 22 with respect to the cabin 20 is determined, the 3D pose of the bucket 18 can be determined based on the determined (Rₘₐᵣₖₑᵣ^{cabin},tₘₐᵣₖₑᵣ^{cabin}) and based on the pre-known and approximate 3D pose of the bucket's terminal end relative to the marker. It has been found that the 3D pose of the bucket 18 can be determined within one inch or better of its actual 3D pose. Furthermore, in this example, 3D poses of other components of the excavator 10 such as the boom 14 can be determined via inverse kinematic calculations.

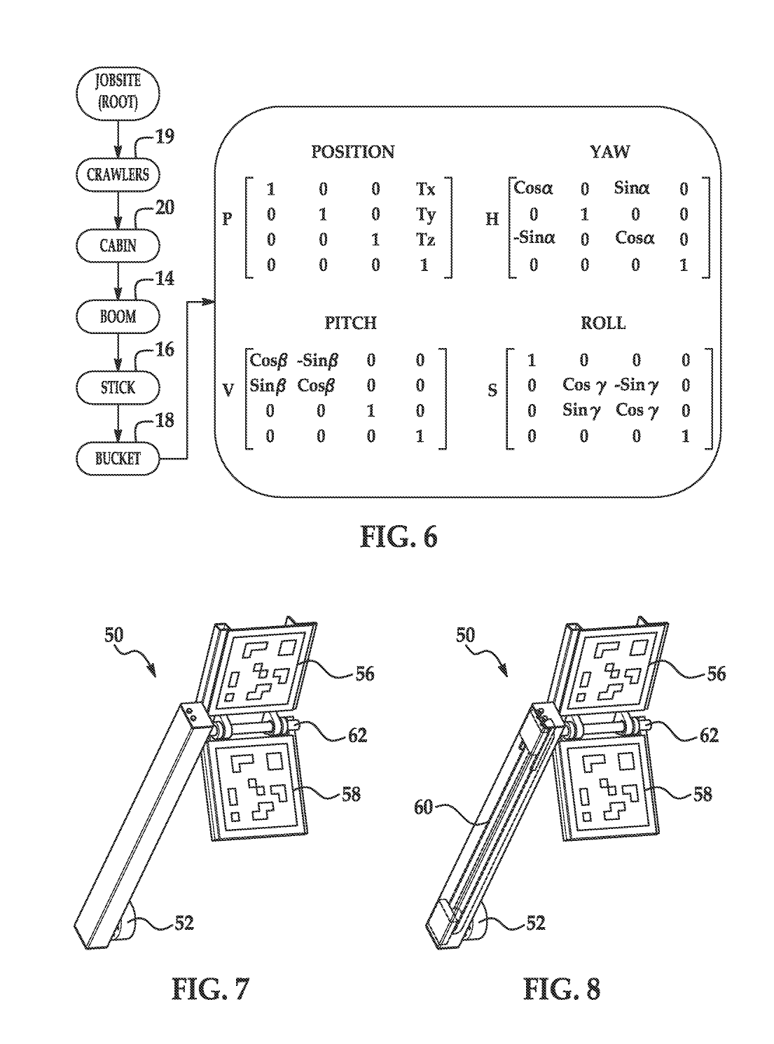

FIG. 6 generally depicts mathematical representations of 3D poses of the excavator's 10 different articulated components. The mathematical representations illustrate matrices for position, yaw, pitch, and roll for the crawlers 19 of the excavator 10, the cabin 20, the boom 14, the stick 16, and the bucket 18. Multiplying the matrix stack here with all 3D poses of parent components relative to child components (e.g., boom 14 to stick 16) can provide the 3D pose of the bucket 18 which is the last link in this kinematic chain.

FIGS. 7 and 8 depict an example of a marker assembly 50 that can optionally be equipped to the bucket 18 in order to mimic and track the pivotal movement of the bucket about the stick 16. The marker assembly 50 mimics and tracks the pivotal movement of the bucket 18 at a distance away from the bucket itself. In this way, the 3D pose of the bucket 18 can be determined without attaching a marker directly to the bucket where its attachment might be impaired and damaged when the bucket digs into the ground during use. One end 52 of the marker assembly 50 can be mechanically interconnected to a joint 54 (FIG. 1) that turns as the bucket 18 pivots. The end 52 turns with the joint 54, and the turning is transferred to a first and second marker 56, 58 via a belt 60 (FIG. 8). The first and second markers 56, 58 hence turn with the joint 54 about an axle 62. One or more cameras can be mounted to the excavator 10 and aimed at the first and second markers 56, 58. With the marker assembly 50, the method and system of estimating 3D pose detailed in this description may more precisely determine the 3D pose of the bucket 18.

Referring now to FIG. 10, in a fifth example the method and system of estimating 3D pose includes a marker 70, a camera 72, and a benchmark 74. The marker 70 in this example has a two-planar conformation with a first plane 76 arranged at an angle with a second plane 78. The marker 70 is carried on a stand 80 on the ground G at a site set away from the excavator 10. The camera 72 is mounted to the base 12 and is carried by a motor 82 that swivels the camera side-to-side and left-to-right (i.e., yaw Y) so that the camera can maintain its image field or zone Z on the marker to take images of the marker as the excavator 10 moves amid its use. The benchmark 74 serves as a reference point for the method and system of estimating 3D pose. The benchmark 74 itself has a known pose, and can be a manhole as depicted in FIG. 10, a lamppost, a corner of a building, a stake in the ground G, or some other item. Whatever the item might be, in addition to having a known pose, the marker 70 in this example is set a predetermined pose P from the benchmark. In other examples, the marker 70 could be set directly on top of, or at, the benchmark 74 in which case the pose transformation matrix would be an identity matrix; here, the marker itself, in a sense, serves as the benchmark. Still, the benchmark 74 can be utilized in other examples depicted in the figures and described, even though a benchmark is not necessarily shown or described along with that example. In the fifth example, the pose of the camera 72 with respect to the marker 70 constitutes the pose of the base 12 with respect to the marker at the location that the camera is mounted to the base. Similarly, the pose of the camera 72 with respect to the benchmark 74 constitutes the pose of the base 12 with respect to the benchmark at the location that the camera is mounted to the base.

Referring now to FIG. 11, in a sixth example the method and system of estimating 3D pose includes a first marker 84, a second marker 86, a first camera 88, and a second camera 90. The first marker 84 is attached to one side of the base 12, and the second marker 86 is attached to another side of the base. Although the image field or zone Z′ of the first camera 88 is illustrated in FIG. 11 as aimed at the first marker 84, the image zone Z′ could be aimed at the second marker 86 in another circumstance where the base 12 rotates clockwise amid its use and hence could take images of the second marker as well. Likewise, although the image field or zone Z″ of the second camera 90 is illustrated as aimed at the second marker 86, the image zone Z″ could be aimed at the first marker 84 in another circumstance where the base 12 rotates counterclockwise amid its use. The first camera 88 is carried on a stand 92 on the ground G at a site set away from the excavator 10, and is carried by a motor 94 that swivels the first camera side-to-side. Similarly, the second camera 90 is carried on a stand 96 on the ground G at a site set away from the excavator 10, and is carried by a motor 98 that swivels the second camera side-to-side. As before, and although not depicted, a benchmark could be used in the set-up of FIG. 11. In the sixth example, the benchmark would be set a predetermined pose from the first camera 88 and from the second camera 90. The predetermined pose could be a different value for each of the first and second cameras 88, 90, or could be the same value. Or, the first and second cameras 88, 90 themselves could serve as the benchmark. In the sixth example, the pose of the first marker 84 with respect to the first camera 88 constitutes the pose of the base 12 with respect to the first camera at the location that the first marker is attached to the base. Similarly, the pose of the second marker 86 with respect to the second camera 90 constitutes the pose of the base 12 with respect to the second camera at the location that the second marker is attached to the base. Still, in other examples similar to the sixth example, additional cameras and markers could be provided.

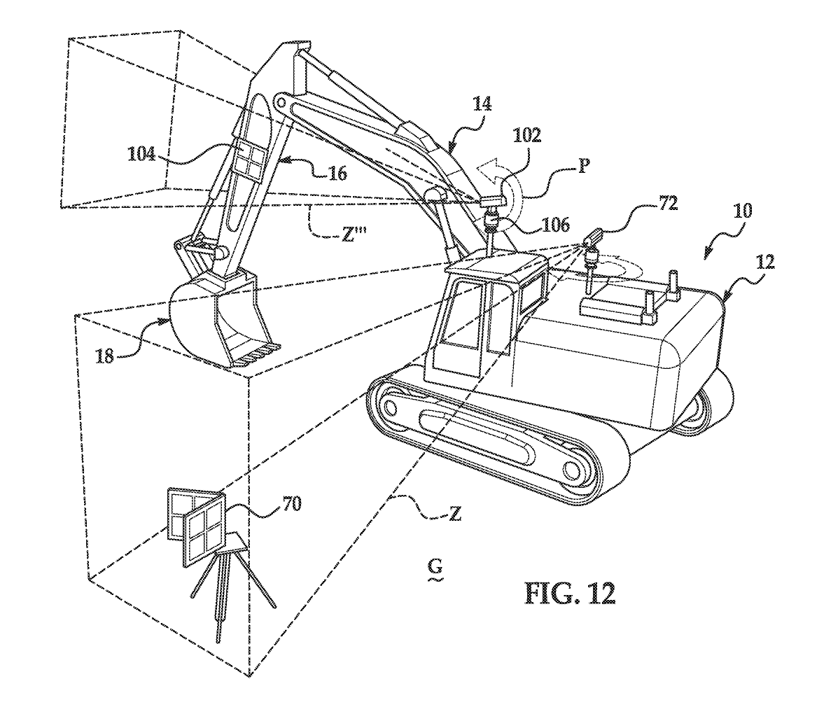

The set-ups of the fifth and sixth examples, as well as other set-ups, can be used to determine the pose of the base 12. Once this is determined—whether by the fifth example, sixth example, or other example—the pose of one or more of the articulated components 14, 16 can be determined. Referring now to FIG. 12, in a seventh example the method and system includes the marker 70 and camera 72 of FIG. 10, and further includes a second camera 102 and a second marker 104. Although the marker 70 and camera 72 are depicted in FIG. 12, the seventh example could instead include the markers 84, 86 and cameras 88, 90 of FIG. 11. The second camera 102 is mounted to the base 12 and is carried by a motor 106 that tilts the second camera up and down (i.e., pitch P) so that the second camera can maintain its image field or zone Z′″ on the second marker 104 to take images of the second marker as the boom 14 and stick 16 move amid their use. The second marker 104 is shown in FIG. 12 as attached to the stick 16, but could be attached to other articulated components such as the boom 14. As before, and although not depicted, a benchmark could be used in the set-up of FIG. 12. Furthermore, the extrinsic calibrations between the camera 72 and second camera 102 are known in the seventh example—that is, the camera 72 and second camera 102 have a predetermined pose. If, for instance, FIG. 12 included the set-up of FIG. 11, then the predetermined pose would instead be between the second camera 102 and the markers 84, 86. In the seventh example, the pose of the second marker 104 with respect to the second camera 102 constitutes the pose of that articulated component with respect to the second camera at the location that the second marker is attached to the stick 16. As previously described, determining the 3D pose in these examples involves forward kinematic calculations. In the seventh example of FIG. 12, for instance, the 3D pose of the articulated part 16 with respect to the benchmark 74 of FIG. 10 can be determined by the equation:

(R_{benchmark}^{articulated part},t_{benchmark}^{articulated part})=(R_{second camera}^{articulated part},t_{second camera}^{articulated part})*(R_{first camera}^{second camera},t_{first camera}^{second camera})*(R_{first marker}^{first camera},t_{first marker}^{first camera})*(R_{benchmark}^{first marker},t_{benchmark}^{first marker})

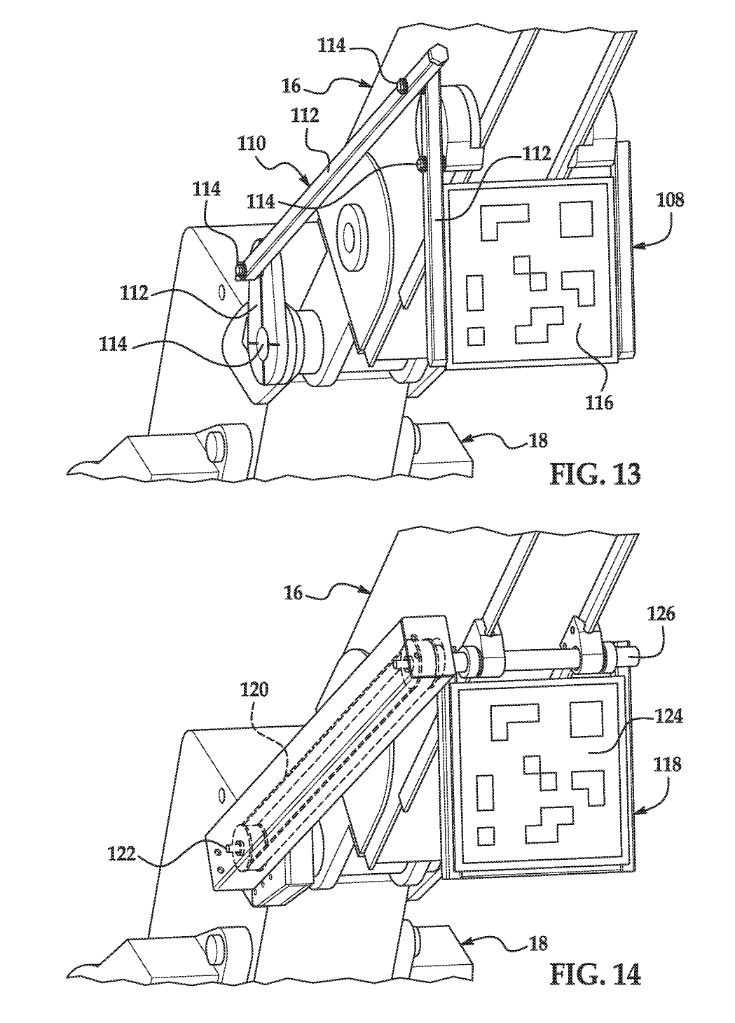

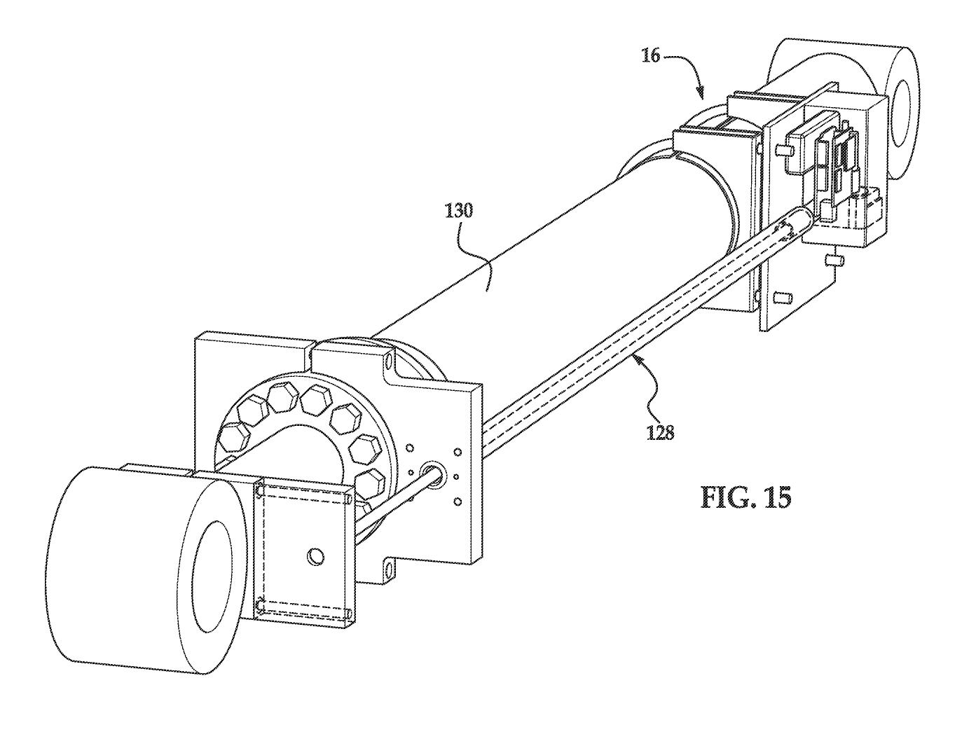

With the pose of the stick 16 determined from FIG. 12, the pose of the end effector 18 can now be determined. There are many techniques that could be used to make this determination. In the example of the excavator 10, determining the pose of the bucket 18 involves detecting the angle at which it is pivoted. FIGS. 13-15 present some example ways for detecting the angle of the bucket 18, but skilled artisans will appreciate that there are many more. In FIG. 13, a marker assembly 108 mimics and tracks the pivotal movement of the bucket 18 about the stick 16. The marker assembly 108 is mounted to the stick 16 and includes a linkage mechanism 110. The linkage mechanism 110 has multiple bars 112 and multiple pivots 114 that work together to transfer the pivotal movement of the bucket 18 to pivotal movement of a marker 116. An accompanying camera (not shown) takes images of the marker 116 as it pivots via the marker assembly 108. Similarly, in FIG. 14, a marker assembly 118 mimics and tracks the pivotal movement of the bucket 18 about the stick 16. The marker assembly 118 is mounted to the stick 16 and includes a belt 120. The marker assembly 118 is mechanically interconnected to a joint 122 that turns as the bucket 18 pivots. The turning is transferred to a marker 124 via the belt 120. The marker 124 pivots about an axle 126 as the joint 122 turns. FIG. 15 presents yet another example for detecting the angle of the bucket 18, but does so without a marker. A sensor in the form of a linear encoder, and specifically a cable potentiometer 128, is mounted to the stick 16 at a cylinder 130 of the bucket 18. As the bucket 18 pivots, the cable potentiometer 128 detects the corresponding position and distance that the cylinder 130 translates. The corresponding position and distance can be wirelessly broadcasted to a controller which can then determine the associated bucket angle. Again, the marker assemblies of FIGS. 13 and 14 and the sensor of FIG. 15 are mere examples, and other examples are possible.

As previously described, determining the 3D pose of the bucket 18 involves forward kinematic calculations. In the seventh example of FIG. 12 and the examples of FIGS. 13-15, for instance, the 3D pose of the end effector 18 with respect to the benchmark 74 of FIG. 10 can be determined by the equation:

(R_{benchmark}^{end effector},t_{benchmark}^{end effector})=(R_{articulated part}^{end effector},t_{articulated part}^{end effector})*(R_{benchmark}^{articulated part},t_{benchmark}^{articulated part})

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of estimating the three-dimensional position and orientation of an articulated machine in real-time using at least one image-capturing device and at least one marker, the method comprising the steps of:
(a) providing the at least one image-capturing device mounted to the articulated machine or located at a site adjacent to the articulated machine;
(b) providing the at least one marker attached to the articulated machine or located at a site adjacent to the articulated machine;
(c) capturing images of the at least one marker via the at least one image-capturing device; and
(d) determining the position and orientation of the at least one image-capturing device with respect to the at least one marker based on the captured images of the at least one marker, or determining the position and orientation of the at least one marker with respect to the at least one image-capturing device based on the captured images of the at least one marker, the position and orientation of the at least one image-capturing device constituting the position and orientation of the articulated machine at the mounting of the at least one image-capturing device to the articulated machine, or the position and orientation of the at least one marker constituting the position and orientation of the articulated machine at the attachment of the at least one marker to the articulated machine.

2. The method of claim 1, wherein the at least one image-capturing device is at least one camera, and the at least one marker has a single planar conformation or a multi-planar conformation.

3. The method of claim 1, wherein the at least one image-capturing device is carried by a motor that swivels the at least one image-capturing device side-to-side in order to capture images of the at least one marker, or that tilts the at least one image-capturing device up and down in order to capture images of the at least one marker.

4. The method of claim 1, further comprising the step of providing a benchmark with a predetermined position and orientation relative to the at least one marker, and determining the position and orientation of the at least one image-capturing device with respect to the benchmark based on the predetermined position and orientation of the benchmark relative to the at least one marker.

5. The method of claim 4, wherein the at least one image-capturing device is mounted to the articulated machine, the at least one marker is located at a site adjacent to the articulated machine, and the position and orientation of the at least one image-capturing device with respect to the benchmark constitutes the position and orientation of the articulated machine with respect to the benchmark at the mounting of the at least one image-capturing device to the articulated machine.

6. The method of claim 1, wherein the at least one image capturing device is located at a site adjacent to the articulated machine, the at least one marker is attached to the articulated machine, and the position and orientation of the at least one marker with respect to the at least one image-capturing device constitutes the position and orientation of the articulated machine with respect to the at least one image-capturing device at the attachment of the at least one marker to the articulated machine.

7. The method of claim 6, further comprising the step of providing a benchmark with a predetermined position and orientation relative to the at least one image-capturing device, and determining the position and orientation of the at least one marker with respect to the benchmark based on the predetermined position and orientation of the benchmark relative to the at least one image-capturing device.

8. The method of claim 7, wherein the at least one image-capturing device comprises a first image-capturing device located at a first site adjacent to the articulated machine and a second image-capturing device located at a second site adjacent to the articulated machine, the at least one marker comprises a first marker attached to the articulated machine at a third site and a second marker attached to the articulated machine at a fourth site.

9. The method of claim 1, wherein the at least one image-capturing device comprises a first image-capturing device and a second image-capturing device, the at least one marker comprises a first marker and a second marker, the first image-capturing device is mounted to a non-articulated component of the articulated machine or is located at the site adjacent to the articulated machine, the first marker is attached to the non-articulated component or is located at the site adjacent to the articulated machine, the first image-capturing device captures images of the first marker and the captured images of the first marker are used to determine the position and orientation of the non-articulated component at the mounting of the first image-capturing device or at the attachment of the first marker.

10. The method of claim 9, wherein the second image-capturing device is mounted to the non-articulated component at a predetermined position and orientation relative to the first image-capturing device mounted to the non-articulated component or relative to the first marker attached to the non-articulated component, the second marker is attached to an articulated component of the articulated machine, the second image-capturing device captures images of the second marker, and the captured images of the second marker and the predetermined position and orientation are used to determine the position and orientation of the articulated component at the attachment of the second marker.

11. The method of claim 9, wherein the second image-capturing device is mounted to the articulated machine, the second image-capturing device captures images of the second marker, the second marker is attached to a marker assembly mounted to an articulated component of the articulated machine and interconnected to an end effector of the articulated machine, the marker assembly moving the second marker as the end effector pivots during use, the captured images of the second marker are used to determine the position and orientation of the end effector.

12. The method of claim 10, further comprising the step of detecting pivotal movement of an end effector of the articulated machine, the detected pivotal movement used to determine the position and orientation of the end effector.

13. The method of claim 9, wherein the second image-capturing device is mounted to the articulated machine, the second image-capturing device captures images of the second marker, the second marker is attached to an end effector of the articulated machine, the captured images of the second marker are used to determine the position and orientation of the end effector.

14. The method of claim 1, wherein the articulated machine is an excavator.

15. A computer readable medium comprising a non-transient date storage device having instructions stored thereon that carry out the method of claim 1.

16. A method of estimating the three-dimensional position and orientation of an articulated machine in real-time using at least one image-capturing device and at least one marker, the method comprising the steps of:
(a) providing the at least one image-capturing device mounted to the articulated machine or located at a site adjacent to the articulated machine;
(b) providing the at least one marker attached to the articulated machine or located at a site adjacent to the articulated machine;
(c) capturing images of the at least one marker via the at least one image-capturing device;
(d) determining the position and orientation of the at least one image-capturing device with respect to the at least one marker based on the captured images of the at least one marker, or determining the position and orientation of the at least one marker with respect to the at least one image-capturing device based on the captured images of the at least one marker;
(e) providing a benchmark with a predetermined position and orientation relative to the at least one image-capturing device or relative to the at least one marker; and
(f) determining the position and orientation of the at least one image-capturing device with respect to the benchmark based on the predetermined position and orientation of the benchmark relative to the at least one marker, or determining the position and orientation of the at least one marker with respect to the benchmark based on the predetermined position and orientation of the benchmark relative to the at least one image-capturing device.

17. The method of claim 16, wherein the position and orientation of the at least one image-capturing device with respect to the benchmark constitutes the position and orientation of the articulated machine with respect to the benchmark at the mounting of the at least one image-capturing device to the articulated machine, or the position and orientation of the at least one marker with respect to the benchmark constitutes the position and orientation of the articulated machine with respect to the benchmark at the attachment of the at least one marker to the articulated machine.

18. The method of claim 16, wherein the articulated machine is an excavator.
